(19) United States
(12) Patent Application Publication
(10) Pub. No.: US 2004/0046676 A1
(43) Pub. Date: Mar. 11, 2004

(54) Multi-status signaling device and method

(76) Inventor: Kenneth R. Taylor, Ivoryton, CT (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/234,393

(22) Filed: Sep. 5, 2002

(51) Int. Cl. G08B 5/22

(52) U.S. Cl. 340/815.45

(57) ABSTRACT

A multi-status visual signaling device is disclosed that includes a light source, positioned under a lens, that transmits light in a first state, until an input is received that causes the light source to transmit light in a second state. When a solid state light source, for example, a light emitting diode (LED), is utilized, the multi-status visual signaling device of the present invention is easy to maintain because the light source does not have to be replaced frequently.

### FIELD OF THE INVENTION

The present invention relates generally to visual signaling devices. More particularly, the present invention is directed to multi-state signaling devices that emit light in more than one pattern and/or color.

### BACKGROUND OF THE INVENTION

Visual signaling devices are often utilized in safety applications to alert or warn of problems. Some safety applications require visual signaling devices to remain constantly energized to indicate the presence or activation state of devices, such as an emergency and alarm devices.

Emergency and alarm devices include emergency call boxes and telephones that are well known in environments that become nearly deserted at night, such as parking lots, hospitals, and college campuses. Emergency and alarm devices also include alarm boxes that are coupled to industrial machines, for use by machine operators, to provide notification of problems to others, such as machine breakdowns or defective products.

Generally, emergency and alarm devices are mounted on poles or placed on top of industrial machines to make the emergency and alarm devices clearly visible from a distance, and easy to locate when individuals are in need of assistance. Upon the occurrence of an emergency-triggering event, for example, when a call is placed from an emergency call box, the emergency call box automatically switches from a first mode, such as a simply lit mode, to a second mode such as a strobe-flicker mode to indicate an alarming condition.

Studies of visual signaling devices, which are utilized for emergency and alarm applications, show that effective warning is best accomplished by signaling devices that combine a bright strobe-like, rapid flickering or pulsing visual light signal with high color intensity. Pulsing color identification is highly desirable in visual signaling devices. For example, a pulsing color, in particular blue, has become an indicator of emergency situations.

Conventionally, visual signaling devices, which constantly remain lit until the occurrence of an emergency, utilize incandescent bulbs, fluorescent bulbs or strobe tubes as sources of light. However, there are disadvantages associated with these conventional light sources.

For example, incandescent bulbs and flourescent bulbs, typically, burn out after 1000 to 3000 hours, and thus, require frequent replacement. Strobe tubes produce light that flashes repeatedly at a chosen frequency. However, strobe tubes are more expensive to manufacture than flourescent and incandescent bulbs, and also tend to have a lifetime of no more than 3000 hours.

Accordingly, it would be desirable to provide light sources that remain energized for long periods of time, require infrequent maintenance and are inexpensive to produce.

### SUMMARY OF THE INVENTION

In one aspect of the present invention, a signaling device is provided that includes a lens, and a solid state light source positioned under the lens, wherein the solid state light source transmits light in a first state, until an input is received that causes the solid state light source to transmit light in a second state.

In another aspect of the present invention, the solid state light source is at least one light emitting diode (LED).

In another aspect of the present invention, the solid state light source, in the first state, transmits light in an unpatterned mode.

In another aspect of the present invention, the solid state light source, in the second state, transmits light in a strobe-flicker pattern.

In another aspect of the present invention, the base is coupled to the lens.

In another aspect of the present invention, a reflector is coupled to the base.

In another aspect of the present invention, the light source originates from a plurality of LED's that are positioned about a post.

In another aspect of the present invention, a signaling system is provided that includes a means for transmitting light utilizing a solid state device that operates in a first state, until an input is received that causes the solid state light source to transmit light in a second state, and a means for covering the light transmitting means.

In another aspect of the present invention, the signaling system includes a power supply.

In another aspect of the present invention, the signaling system includes a PLC.

In yet another aspect of the present invention, a method for transmitting light from a signaling device is provided that includes transmitting light in a first state from a solid state light source and transmitting light in a second state from the solid state source upon receipt of an input signal.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

### BRIEF DESCRIPTION OF THE DRAWINGS

FIG. 1 is a front exploded view of a signaling device in accordance with the present invention.

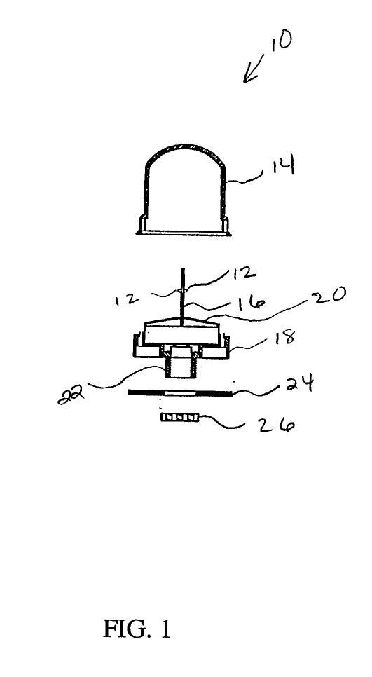

FIG. 2 is a front elevation view of a light source of a signaling device in accordance with the present invention.

FIG. 3 is a signaling system in accordance with the present invention.

### DETAILED DESCRIPTION OF PREFERRED EMBODIMENTS OF THE INVENTION

Referring now to the figures, wherein like reference numerals indicate like elements, there is shown a multi-status visual signaling device 10, in accordance with the present invention, that operates in a first mode or state until an input signal is received that causes the signaling device 10 to emit light in a second mode or state.

In a preferred embodiment of the present invention, the signaling device 10 is utilized, in a first mode, to output light of a single color, and includes a light source 12, which emits a single color of light that is covered by a lens 14 that is of a similar color to the light emitted by the light source. More preferably, the signaling device 10 is designed to transmit blue, red, amber, green or white light from inside a similarly colored lens 14.

In the preferred embodiment of the present invention, the light source 12 is a solid state light emitting diode (LED). An advantage of utilizing a solid state LED is that it is a semi-conductor device that requires a small voltage for operation, for example, five volts, and has a typical lifetime of approximately 120,000 hours. The signaling device 10 of the present invention operates electronically without any mechanical parts, and requires infrequent replacement. For the reasons discussed above, it is inexpensive to maintain a signaling device 10 in accordance with the present invention.

In an exemplary embodiment of the present invention, the light source is a plurality of solid state LEDs positioned about a post 16. The lens 14 is preferably constructed in the shape of a dome and made from a plastic material, for example, polycarbonate. However, it should be understood by one of ordinary skill in the art that the shape and the construction material of the lens may vary.

The lens 14 is coupled to a base 18 by, for example, a screw or an adhesive. A reflector 20 may be provided with the base 18 of the signaling device to reflect light that is directed downward towards the base 18 upward, such that the amount of light transmitted out of the lens 14 is increased. The reflector 20 is preferably conically shaped. However, it should be understood by one of ordinary skill in the art that the shape and size of the reflector 20 may vary.

In an exemplary embodiment of the present invention, the base 18 has a threaded stem 22 that allows the signaling device to be threadedly coupled to, for example, a stalk or directly onto a machine. A mounting surface 24 may be provided between the signaling device 10 and an object to which the signaling device 10 is mounted. A securing device 26, for example a locking nut, may be provided to secure the signaling device 10 to the object on which the signaling device 10 is mounted.

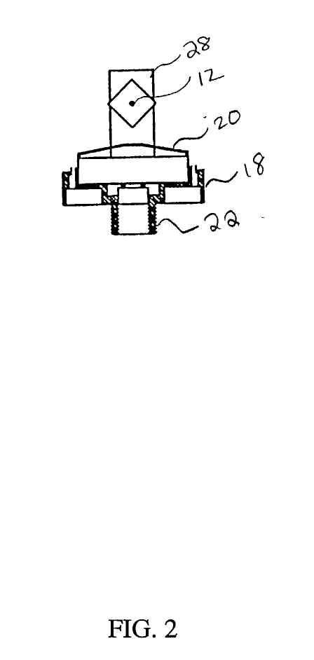

Shown in FIG. 2, the light source 12 includes a solid state LED mounted on a planar surface 28. Coupled to the planar surface 28 is a mounting portion 30, which made be made from metal, that sinks heat generated from the light source 12 to prevent the light source 12 from prematurely burning out. In another exemplary embodiment of the present invention the light source 12 is coupled to a mounting portion 30 that is mounted between two posts

The multi-status signaling device of the present invention is designed to operate in more than one state. In a preferred embodiment of the present invention, the signaling device remains in a first state until an input is received that changes the status of the signaling device 10.

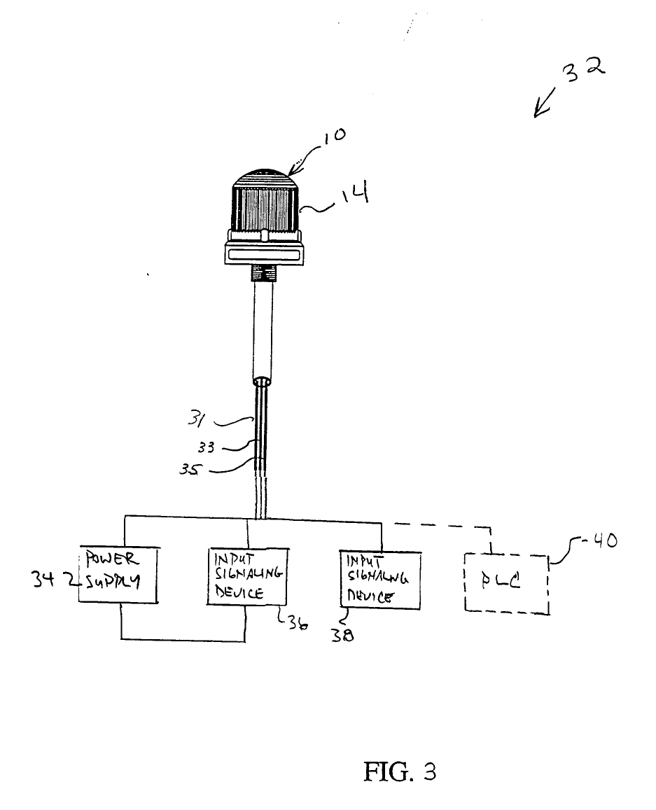

Shown in FIG. 3, is a signaling system 32 in accordance with a preferred embodiment of the present invention. The signaling system 32 includes a signaling device 10 that is electrically coupled to a power supply 34, for example an alternating current (AC) voltage source, and two input signaling devices 36, 38 for example, switches.

Upon activation of the first input signaling device 36, 38, for example, an on/off switch, the signaling device 10 receives power from the power supply 34, and the signaling device 10 transmits light, for example, uniformly, through the lens 14. Upon activation of the second input signaling device 36, 38, for example, by picking up a phone coupled to the signaling device 10, the signaling device 10 transmits light in a second mode, for example, in a strobe-flicker pattern. Further, the lens 14, as shown in FIG. 3, has a striated surface that enhances distinctiveness of the strobe flicker-pattern

In an exemplary embodiment of the present invention the strobe-flicker pattern is generated by circuitry known in the art. In a preferred embodiment of the present invention, the input signaling devices are normally open contact switches, such that when an open circuit of each switch is closed, the signaling device 10 receives an input signal, for example, via conductive wires 31, 33, 35. It should be understood by one of ordinary skill in the art that the type of input signaling devices utilized may vary.

Alternatively, a programmable logic controller (PLC) 40 may be coupled to the signaling device to control the mode of the signaling device 10. A PLC 40 is a control device that stores instructions for commanding a device to which it is coupled, upon the occurrence of an event.

Multiple light patterns and/or colors, which correspond to modes or states of the signaling device 10, can be programmed into and stored on the PLC 40, such that a specific instruction is associated with a particular event, for example, the activation and/or deactivation of a switch. Accordingly, upon the activation of a switch, the PLC 40 will command the signaling device in accordance with the instructions associated with the activation of that switch.

Accordingly, a signaling device 10 in accordance with the present invention is operable in more than one state/mode and thus, can be utilized to transmit light in more than one pattern and/or color.

In some embodiments, all the LED's making up the light source 12 are of the same color. The change over from state to state may involve changing from a constant solid light to a flickering or pulsing light or to a broken light, or to a different number of LED's being lit. Alternatively, the LED's may be multicolor LED's, or the light source 12 may have LED's of different colors. In this case, in addition to or instead of the changes above, the change between states may also include changing the color of the light emitted by the light source 12.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A signaling device, comprising:
a lens; and
a solid state light source positioned under the lens, wherein the solid state light source transmits light in a first state, until an input is received that causes the solid state light source to transmit light in a second state.

2. The signaling device of claim 1, wherein the solid state light source is at least one LED.

3. The signaling device of claim 1, wherein the solid state light source, in the first state, transmits light in an unpatterned mode.

4. The signaling device of claim 1, wherein the solid state light source, in the second state, transmits light in a strobe-flicker pattern.

5. The signaling device of claim 1, further comprising a base, wherein the base is coupled to the lens.

6. The signaling device of claim 5, further comprising a reflector, wherein the reflector is coupled to the base.

7. The signaling device of claim 2, wherein the at least one LED is a plurality of LED's.

8. The signaling device of claim 7, further comprising a post coupled to the base, and wherein the plurality of LED's is positioned about the post.

9. The signaling system of claim 1, further comprising a planar surface, and wherein the solid state light source is coupled to the planar surface.

10. The signaling systems of claim 5, wherein the base includes a threaded stem.

11. The signaling system of claim 1, wherein the lens has a striated surface.

12. The signaling device of claim 1, wherein the solid state light source transmits a light similar in color to a color of the lens.

13. A signaling system, comprising:
means for transmitting light utilizing a solid state device that operates in a first state, until an input is received that causes the solid state light source to transmit light in a second state; and
means for covering the light transmitting means.

14. The signaling system of claim 13, wherein the solid state device is an LED.

15. The signaling system of claim 13, further comprising:
means for supplying power to the signaling system.

16. The signaling system of claim 15, wherein the power supplying means is an AC voltage source.

17. The signaling system of claim 13, further comprising:
a PLC, wherein the PLC provides the input that causes the signaling device to transmit light in a second state.

18. The signaling system of claim 13, wherein the light transmitting means, in the second state, transmits light in a strobe-flicker pattern.

19. The signaling system of claim 13, further comprising:
a switch, wherein the switch causes the signaling device to transmit light in a first state.

20. A method of transmitting light from a signaling device, comprising:
transmitting light in a first state from a solid state light source; and
transmitting light in a second state from the solid state source upon receipt of an input signal.
